(19) United States
(12) Patent Application Publication
(10) Pub. No.: US 2010/0138074 A1
(43) Pub. Date: Jun. 3, 2010

(54) COMPUTER SYSTEM

(75) Inventors: Li-Hong Huang, Shanghai City (CN); Hai-Ming Luo, Shanghai City (CN); Shih-Hao Liu, Taipei City (TW)

Correspondence Address: J C PATENTS, 4 VENTURE, SUITE 250, IRVINE, CA, 92618, US

(73) Assignee: INVENTEC CORPORATION, Taipei City (TW)

(21) Appl. No.: 12/401,105

(22) Filed: Mar. 10, 2009

(30) Foreign Application Priority Data
Nov. 28, 2008 (TW) 97146334

(51) Int. Cl. G05D 23/00

(52) U.S. Cl. 700/300

(57) ABSTRACT

A computer system including a chassis, a plurality of motherboards, a fan control module and a plurality of fans is provided. A plurality of motherboard position signal generating units is disposed in the chassis. Each of the motherboards includes a signal generating circuit and a board management controller. The signal generating circuit coordinates with one of the motherboard position signal generating units to generate a motherboard position signal. The board management controller receives the motherboard position signal and a motherboard working temperature signal to output a motherboard working state signal. The fan control module coupled to the board management controller of each of the motherboards receives the motherboard working state signals and generates a plurality of fan control signals accordingly. The fans coupled to the fan control module determine operation according the fan control signals.

### CROSS-REFERENCE TO RELATED APPLICATION

This application claims the priority benefit of Taiwan application serial no. 97146334, filed Nov. 28, 2008. The entirety of the above-mentioned patent application is hereby incorporated by reference herein and made a part of specification.

### BACKGROUND OF THE INVENTION

1. Field of the Invention

The present invention is related to fan operation control technology, and particularly to a computer system capable of controlling fan operation.

2. Description of Related Art

Generally, a plurality of motherboards is disposed in a chassis of a server or a computer system. Elements disposed on the motherboards (e.g., a central processing unit (CPU) and the like) generate high temperature during operation, and to prevent operation efficiency of the elements from being affected by the high temperature or the elements from being burned down thereby, relevant measures need to be taken to dissipate heat. In other words, corresponding fans are to be disposed around the motherboards so that the high temperature generated by the elements thereon can be reduced.

However, during the operation of a server or a computer system and whether or not all of the motherboards are at work, all the fans operate altogether. Even if only one of the motherboards is working, all the fans still operate altogether. Since the fans do not stop operating because their corresponding motherboards are not operating, some of the fans would be idling such that power consumption and noise are increased.

### SUMMARY OF THE INVENTION

The present invention provides a computer system which effectively prevents some fans from idling so as to reduce power consumption and noise.

The present invention provides a computer system including a chassis, a plurality of motherboards, a fan control module and a plurality of fans. A plurality of motherboard position signal generating units is disposed in the chassis. Each of the motherboards includes a signal generating circuit and a board management controller (BMC). The signal generating circuit coordinates with one of the motherboard position signal generating units in the chassis to generate a motherboard position signal. The board management controller receives the motherboard position signal and a motherboard working temperature signal and outputs a motherboard working state signal. The fan control module coupled to the board management controller receives the motherboard working state signal to generate a plurality of fan control signals accordingly. The fans are coupled to the fan control module and determine whether to operate according to the fan control signals.

According to an embodiment of the present invention, the fan control module includes a total controller and a fan controller. The total controller receives the motherboard working state signal from the board management controller and sends a total fan control signal. The fan controller receives and converts the total fan control signal into a plurality of fan control signals to control operation of the corresponding fans.

According to an embodiment of the present invention, signals are transmitted between the board management controller and the fan control module through an inter-integrated circuit (I2C) bus.

According to an embodiment of the present invention, the fan control module sets up a correlation between each of the motherboards and the fan in a corresponding position and controls only those fans corresponding to the working motherboards to operate.

According to an embodiment of the present invention, the fan control module determines an operating speed of the corresponding fan according to a working temperature of the motherboard.

According to an embodiment of the present invention, the signal generating circuit of the motherboard contacts with the motherboard position signal generating unit on the chassis to generate a motherboard position signal so as to show a motherboard being disposed in a physical position on the chassis.

According to an embodiment of the present invention, each of the motherboard position signal generating unit includes a body and a plurality of conductors. The body has a plurality of receptacles. The conductors are optionally disposed in the receptacles.

According to an embodiment of the present invention, the signal generating circuit includes a plurality of pins. When at least a portion of the pins contact with at least a portion of the conductors, the motherboard position signal is generated.

According to an embodiment of the present invention, the pins are connected to a power source terminal, and the conductors are connected to a ground terminal.

According to an embodiment of the present invention, after the pins contact with the conductors, a low-level signal is generated. When the pins have not contacted with the conductors, a high-level signal is generated.

In the present invention, the signal generating circuit in each of the motherboards coordinates with the motherboard position signal generating unit on the chassis to generate the motherboard position signal. Afterwards, when the motherboard is mounted on the chassis and at work, the board management controller receives the motherboard position signal and the motherboard working temperature signal and outputs the motherboard working state signal. Thereafter, the fan control module generates fan control signals to control operation of the corresponding fans according to the motherboard working state signal. Thus, the situation where some of the fans run idle is effectively avoided so that power consumption and noise are reduced. In addition, the fan control module of the present invention can further determine an operating speed of the corresponding fans according to the motherboard working temperature.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a computer system according to an embodiment of the present invention.

FIG. 2 is a schematic view of a motherboard position signal generating unit according to an embodiment of the present invention.

FIG. 3 is a locally-enlarged view of a motherboard position signal generating unit according to an embodiment of the present invention.

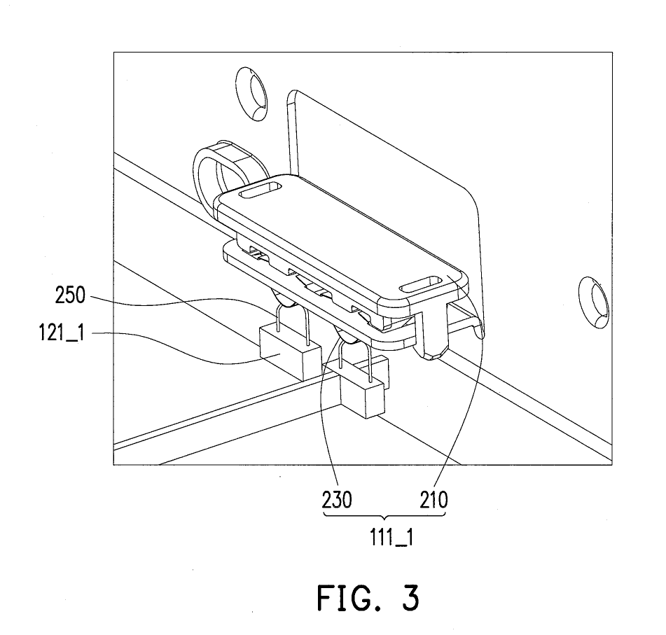

FIG. 4 is a schematic view of circuit connection between a signal generating circuit and a motherboard position signal generating unit according to an embodiment of the present invention.

### DESCRIPTION OF EMBODIMENTS

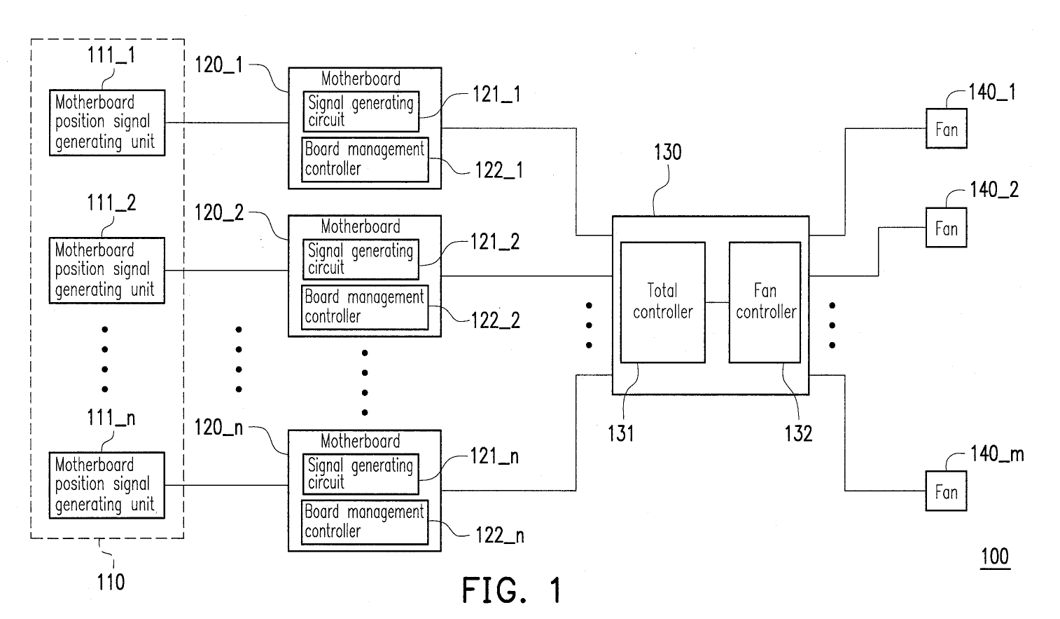

FIG. 1 is a schematic block diagram of a computer system according to an embodiment of the present invention. Referring to FIG. 1, a computer system 100 includes a chassis 110, motherboards 120_1˜120_{—}n, a fan control module 130 and fans 140_1˜140_{—}m. n and m are positive integers larger than zero, and n and m can be set as the same or different.

Motherboard position signal generating units 111_1˜111_{—}n are disposed in the chassis 110. The motherboards 120_1˜120_{—}n include signal generating circuits 121_1˜121_{—}n and board management controllers (BMC) 122_1˜122_{—}n. The signal generating circuits 121_1˜121_{—}n coordinate with the motherboard position signal generating units 111_1˜111_{—}n to generate motherboard position signals. The board management controllers 122_1˜122_{—}n receive the motherboard position signals and motherboard working temperature signals and output working state signals of the motherboards 120_1˜120_{—}n.

The fan control module 130 coupled to the board management controllers 122_1˜122_{—}n receive the motherboard working state signals to generate a plurality of fan control signals accordingly. The fans 140_1˜140_{—}m are coupled to the fan control module 130 and determine whether to operate according to the corresponding fan control signals respectively. According to the present embodiment, signals are transmitted between the board management controllers 122_1˜122_{—}n and the fan control module 130 through an inter-integrated circuit (I2C) bus.

To facilitate illustration, suppose the number of the motherboards is 4 (n=4), i.e., the motherboards 120_1˜120_4. The number of the fans is 5, i.e., the fans 140_1˜140_5. Since the signal generating circuit and the board management controller each correspond to a motherboard, the numbers of the signal generating circuits and the board management controllers are both 4, i.e., the signal generating circuits 121_1˜121_4 and the board management controllers 122_1˜122_4. Furthermore, the motherboard position signal generating unit coordinates with the signal generating unit so that the number of the motherboard position signal generating units is also 4, i.e., the motherboard position signal generating units 111_1˜111_4.

The correlation between the motherboards 120_1˜120_4 and the fans 140_1˜140_5 is as follows: The motherboard 120_1 corresponds to the fans 140_1 and 140_2; the motherboard 120_2 corresponds to the fans 140_2; the motherboard 120_3 corresponds to the fan 140_3, and the motherboard 120_4 corresponds to the fan 140_5. Moreover, when the motherboards 120_1˜120_4 are mounted on the chassis 110 and operating, the signal generating circuits 121_1˜121_4 coordinate with the motherboard position signal generating units 111_1˜111_4 to generate motherboard position signals respectively, e.g., “00”, “01”, “10” and “11” correspondingly.

For example, when the motherboard 120_1 is mounted on the chassis 110 and at work, the signal generating circuit 121_1 coordinates with the motherboard position signal generating unit 111_1 to generate the motherboard position signal “00” to the board management controller 122_1. Afterwards, the board management controller 122_1 receives the motherboard position signal “00” and the motherboard working temperature signal of the motherboard 120_1 to output the motherboard working state signal of the motherboard 120_1 to the fan control module 130. At this moment, the fan control module 130 generates a logic high-level fan control signal to the fans 140_1 and 140_2 so that the fans 140_1 and 140_2 start operating to reduce a high temperature produced by the motherboard 120_1.

On the other hand, the motherboards 120_2˜120_4 are not mounted on the chassis 110, and thus the fans 140_3˜140_5 do not operate. Accordingly, the situation where some of the motherboards are not working but their corresponding fans are idling does not occur in the computer system 100.

Furthermore, when the motherboards 120_1 and 120_2 are mounted on the chassis 110 and at work, the signal generating circuits 121_1 and 121_2 coordinate with the motherboard position signal generating units 111_1 and 111_2 to generate the motherboard position signals “00” and “01” to the board management controllers 122_1 and 122_2. Afterwards, the board management controllers 122_1 and 122_2 receive the motherboard position signals “00” and “01” and the motherboard working temperature signals of the motherboards 120_1 and 120_2 so as to output the motherboard working state signals of the motherboards 120_1 and 120_2 to the fan control module 130. At this moment, the fan control module 130 generates logic high-level fan control signals to the fans 140_1, 140_2 and 140_3 so that the fans 140_1, 140_2 and 140_3 start operating to reduce a high temperature produced by the motherboards 120_1 and 120_2.

On the other hand, the motherboards 120_3˜120_4 are not mounted on the chassis 110, and therefore the fans 140_4˜140_5 do not operate. Accordingly, the situation where some of the motherboards are not working but their corresponding fans are idling does not occur in the computer system 100.

Additionally, when the motherboards 120_1˜120_3 are mounted on the chassis 110 and at work, the signal generating circuits 121_1˜121_3 coordinate with the motherboard position signal generating units 111_1˜111_3 to generate the motherboard position signals “00”, “01” and “10” to the board management controllers 122_1˜122_3. Afterwards, the board management controllers 122_1˜122_3 receive the motherboard position signals “00”, “01” and “10” and the motherboard working temperature signals of the motherboards 120_1˜120_3 to output the motherboard working state signals of the motherboards 120_1˜120_3 to the fan control module 130. At this moment, the fan control module 130 generates logic high-level fan control signals to the fans 140_1˜140_4 so that the fans 140_1˜140_4 start operating to reduce the high temperature produced by the motherboards 120_1˜120_3.

On the other hand, the motherboard 120_4 is not mounted on the chassis 110, and therefore the fan 140_5 does not operate. Accordingly, the situation where some of the motherboards are not working but their corresponding fans are idling does not occur in the computer system 100.

Additionally, when the motherboards 120_1˜120_4 are all mounted on the chassis 110 and at work, the signal generating circuits 121_1˜121_4 coordinate with the motherboard position signal generating units 111_1˜111_4 to generate the motherboard position signals “00”, “01”, “10” and “11” to the board management controllers 122_1˜122_4. Afterwards, the board management controllers 122_1˜122_4 receive the motherboard position signals “00”, “01”, “10” and “11” and the motherboard working temperature signals of the motherboards 120_1˜120_4 to output the motherboard working state signals of the motherboards 120_1˜120_4 to the fan control module 130. At this moment, the fan control module 130 generates logic high-level fan control signals to the fans 140_1˜140_5 so that the fans 140_1˜140_5 all start operating to reduce the temperature produced by the motherboards 120_1˜120_{—}n. Thus, the computer system 100 prevents some of the fans from idling. The correlation between the motherboards 120_1˜120_4 at work and whether the corresponding fans 140_1˜140_5 are operating can be referred to the above description and therefore is not repeated herein. Moreover, the foregoing embodiment is only one embodiment of the present invention, and people having ordinary skill in the art may infer the other implementing methods from the above embodiment, and thus the other embodiments are not repeated herein.

According to the present embodiment, since the board management controller receives the motherboard working temperature signal, the motherboard working state signal generated by the board management controller has a working temperature information of the motherboard. Hence, when the fan control module receives the motherboard working state signal, the fan control module determines the operating speed of the corresponding fan(s) according to the motherboard working temperature information.

For example, when the motherboard 120_1 is mounted on the chassis 110 and at work, the board management controller 122_1 can receive the working temperature signal of the motherboard 120_1. Further, when the temperature produced by the motherboard 120_1 at work is higher, so the working state signal of the motherboard 120_1 outputted by the board management controller 122_1 has a “high” working temperature information. Thus, the fan control module 130 correspondingly generates, for example, a pulse width modulation signal with a higher frequency to the fans 140_1 and 140_2 so that the operating speed of the fans 140_1 and 140_2 is accelerated to rapidly lower the high temperature produced by the motherboard 120_1.

On the contrary, when the temperature produced by the motherboard 120_1 at work is lower, the working state signal of the motherboard 120_1 outputted by the board management controller 122_1 has a “low” working temperature information. Thus, the fan control module 130 correspondingly generates, for example, a pulse width modulation signal with a lower frequency to the fans 140_1 and 140_2 so that the operating speed of the fans 140_1 and 140_2 is slowed down to reduce power consumption. Modulation of the operating speeds of the corresponding fans 140_2˜140_{—}m can be referred to the above description when the remaining motherboards 120_2˜120_{—}n at work and is therefore not repeated herein.

According to the present embodiment, the fan control module 130 includes a total controller 131 and a fan controller 132. The total controller 131 receives the motherboard working state signals of the board management controllers 122_1˜122_{—}n and sends a total fan control signal. The fan controller 132 receives and converts the total fan control signal into a plurality of fan control signals to control operation of the corresponding fans 140_1˜140_{—}m.

According to the present embodiment, the signal generating circuits 121_1˜121_4 of the motherboards 120_1˜120_4 contact with the motherboard position signal generating units 111_1˜111_4 on the chassis 110 to generate motherboard position signals respectively so as to show the motherboards being disposed in physical positions on the chassis 110.

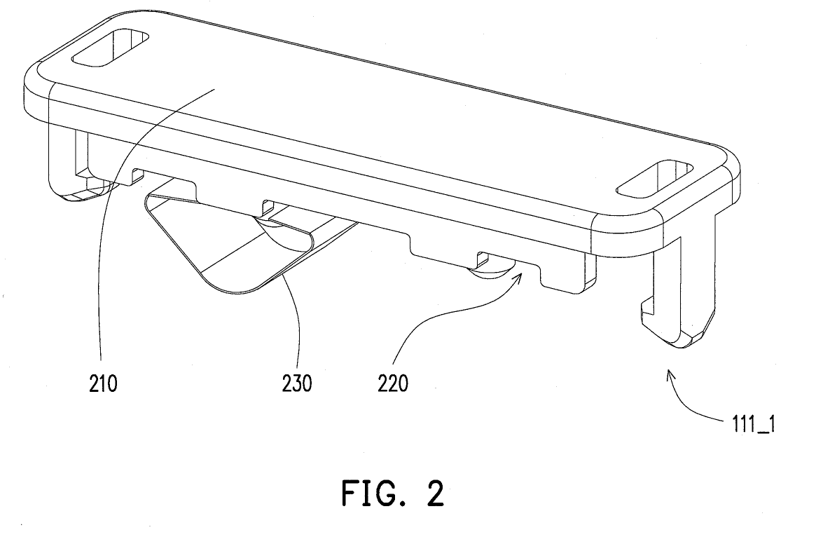

Moreover, the motherboard position signal generating unit 111_1 of the present embodiment includes a body 210 and a plurality of conductors 220, as shown in FIGS. 2A and 2B. The body 210 has a plurality of receptacles 230. The conductors 220 are disposed in the receptacles 230. Inner structures of the remaining motherboard position signal generating units 111_2˜111_4 are the same as the motherboard position signal generating unit 111_1 and are thus omitted herein.

Furthermore, the signal generating circuit 121_1 includes a plurality of pins 250. After at least a portion of the pins 250 contact with at least a portion of the conductors 220, the motherboard position signals are generated. In addition, the pins 250 of the signal generating circuits 121_1˜121_4 are connected to a power source terminal, such as P3V3, and the conductors 220 of the motherboard position signal generating units 111_1˜111_4 are connected to a ground terminal.

For example, suppose the signal generating circuit 121_1 has two pins, and the motherboard position signal generating unit 111_1 has two conductors. When the motherboard 120_1 is mounted on the chassis 110 and the signal generating circuit 121_1 of the motherboard 120_1 contacts with the motherboard position signal generating unit 111_1 on the chassis 110, meaning after the two pins of the signal generating circuit 121_1 contact with the conductors 230, the motherboard position signal of the motherboard 120_1, such as “00”, is generated.

Further, suppose the signal generating circuit 121_2 has two pins, and the motherboard position signal generating unit 111_2 has one conductor. When the motherboard 120_2 is mounted on the chassis 110 and the signal generating circuit 121_2 of the motherboard 120_2 contacts with the motherboard position signal generating unit 111_2 on the chassis 110, meaning after the two pins of the signal generating circuit 121_2 contact with the conductor 230, the motherboard position signal of the motherboard 120_2, such as “01”, is produced.

Suppose the signal generating circuit 121_3 has two pins, and the motherboard position signal generating unit 111_3 has one conductor, and the position of the conductor of the motherboard position signal generating unit 111_3 is different from the conductor of the motherboard position signal generating unit 111_2. In other words, when the motherboard 120_3 is mounted on the chassis 110 and the signal generating circuit 121_3 contacts with the motherboard position signal generating unit 111_3 on the chassis 110, meaning after the two pins of the signal generating circuit 121_3 contact with the conductor 230, the motherboard position signal of the motherboard 120_3, such as “10”, is generated.

Suppose the signal generating circuit 121_4 has two pins, and the motherboard position signal generating unit 111_4 does not have any conductor disposed therein, when the motherboard 120_4 is mounted on the chassis 110, the motherboard position signal, such as “11” is generated.

Based on the above description, people skilled in the art can generate different motherboard position signals by changing the number and positions of the conductors in the motherboard position signal generating unit. Consequently, the operation of the corresponding fans is effectively controlled to avoid idling of some of the fans.

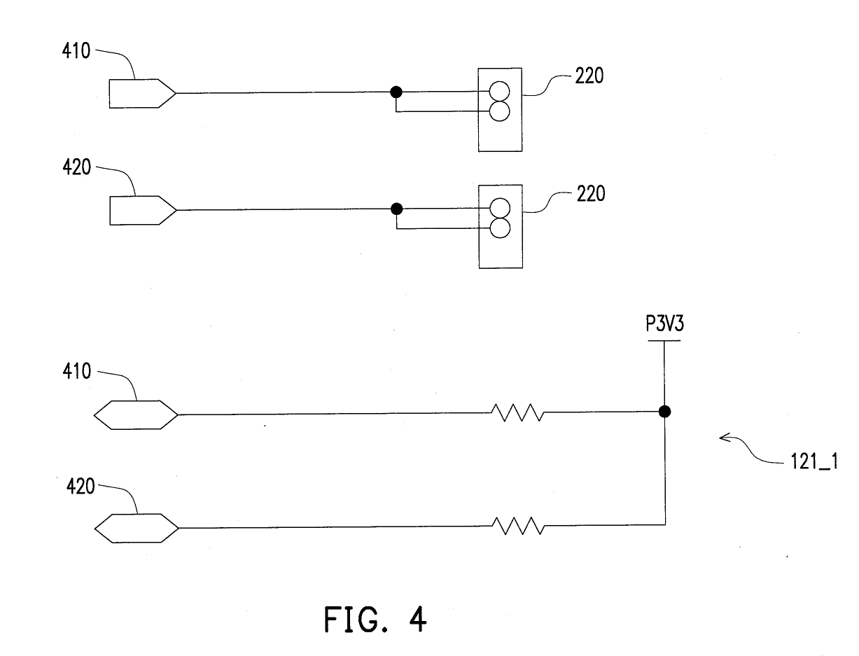

FIG. 4 is a schematic view of circuit connection between a signal generating circuit and a motherboard position signal generating unit according to an embodiment of the present invention. Referring to FIG. 4, “410” and “420” represent pins of the signal generating circuit 121_1, and the pins 410 and 420 are connected to the power source terminal P3V3 through resistors respectively. “220” represents the conductor of the motherboard position signal generating unit 111_1, and the conductor 220 is connected to a ground terminal. When the motherboard 121_1 is mounted on the chassis 110, the pins 410 and 420 contact with the conductor 220 to generate the motherboard position signal “00”. The circuit connection between the remaining signal generating circuits 121_2˜121_{—}n and the motherboard position signal generating units 111_2˜111_{—}n can be inferred by referring to the above description and therefore is not repeated herein.

In summary, in the present invention, the signal generating circuits on the motherboards and the motherboard position signal generating units on the chassis correspondingly coordinate with each other to generate the motherboard position signals so as to determine which motherboard is to be mounted on chassis accordingly. Afterwards, when the motherboard is mounted on the chassis and at work, the board management controller receives the motherboard position signal and the motherboard working temperature signal to output the motherboard working state signal. Thereafter, the fan control module generates the fan control signals according to the motherboard working state signal so as to control operation of the corresponding fans. Consequently, idling of some of the fans is effectively avoided so that the power consumption and noise are reduced. In addition, the fan control module further determines the operating speed of the corresponding fans according to the temperature produced while the motherboard is at work.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer system, comprising:
a chassis, a plurality of motherboard position signal generating units being disposed therein;
a plurality of motherboards, each of the plurality of motherboards comprising:
a signal generating circuit, coordinating with one of the plurality of motherboard position signal generating units on the chassis to generate a motherboard position signal; and
a board management controller (BMC), receiving the motherboard position signal and a motherboard working temperature signal and outputting a motherboard working state signal;
a fan control module, coupled to the board management controller of each of the plurality of motherboards, and receiving the plurality of motherboard working state signals to generate a plurality of fan control signals accordingly; and
a plurality of fans, coupled to the fan control module and determining operation of the plurality of fans according to the plurality of fan control signals.

2. The computer system as claimed in claim 1, wherein the fan control unit comprises:
a total controller, receiving the motherboard working state signal from the board management controller of each of the plurality of motherboards and sending a total fan control signal; and
a fan controller, receiving and converting the total fan control signal into a plurality of fan control signals to control operation of the corresponding fans.

3. The computer system as claimed in claim 1, wherein signals are transmitted between the board management controller of each of the plurality of motherboards and the fan control module through an inter-integrated circuit (I2C) bus.

4. The computer system as claimed in claim 1, wherein the fan control module sets a correlation between each of the motherboards and the fans in corresponding positions and controls only those fans corresponding to the motherboards at work to operate.

5. The computer system as claimed in claim 1, wherein the fan control module determines an operating speed of the corresponding fans according to a working temperature information of the motherboards.

6. The computer system as claimed in claim 1, wherein the signal generating circuit of one of the motherboards contacts with one of the motherboard position signal generating units on the chassis to generate the motherboard position signal so as to show a motherboard being mounted on the chassis in one of a plurality of physical positions.

7. The computer system as claimed in claim 1, wherein each of the motherboard position signal generating units comprises:
a body, having a plurality of receptacles; and
a plurality of conductors, optionally disposed in the receptacles.

8. The computer system as claimed in claim 1, wherein the signal generating circuits comprise a plurality of pins, and when at least a portion of the pins contact with at least a portion of the conductors, the motherboard position signal is generated.

9. The computer system as claimed in claim 8, wherein the pins are connected to a power source terminal, and the conductors are connected to a ground terminal.

10. The computer system as claimed in claim 9, wherein after the pins contact with the conductors, a low-level signal is generated, and when the pins have not yet contacted with the conductors, a high-level signal is generated.
